(19) United States
(12) Patent Application Publication
(10) Pub. No.: US 2026/0260454 A1
(43) Pub. Date: Sep. 3, 2026

(54) DATA PROCESSING METHOD AND DEVICE

(71) Applicant: Smarter Silicon (Shanghai) Technologies Co., Ltd., Shanghai (CN)

(72) Inventors: Xutao ZHANG, Shanghai (CN); Xiuping CHEN, Shanghai (CN)

(21) Appl. No.: 19/542,771

(22) Filed: Feb. 18, 2026

(30) Foreign Application Priority Data
Feb. 28, 2025 (CN) 202510239155.9

(51) Int. Cl. G06V 10/56; G06T 1/60; G06V 10/74

(52) U.S. Cl. CPC G06V 10/56; G06T 1/60; G06V 10/761

(57) ABSTRACT

A method for data processing includes: obtaining pixel data; determining, according to the pixel data, target type information of the pixel data; obtaining, based on the target type information and mapping unit information determined according to the pixel data, target vertex data corresponding to the target sub-mapping-unit; and, performing interpolation processing on the pixel data according to the target vertex data to obtain a color adjustment result corresponding to the pixel data. The target type information indicates a type of a target sub-mapping-unit to which the pixel data belongs. The mapping unit information indicates a target mapping unit to which the pixel data belongs, the target sub-mapping-unit is one of a plurality of sub-mapping-units included in the target mapping unit, and the target vertex data is a portion of vertex data corresponding to the target mapping unit.

### CROSS-REFERENCES TO RELATED APPLICATIONS

The present disclosure claims priority to Chinese Patent Application No. 202510239155.9, filed on Feb. 28, 2025, the content of which is incorporated herein by reference in its entirety.

### TECHNICAL FIELD

The present disclosure relates to the technical field of data processing, and more specifically, relates to a data processing method and device.

### BACKGROUND

A three-dimensional look-up table (3D Look Up Table, 3D-LUT) is a color mapping table commonly used for color adjustment of pixels in images and videos. A three-dimensional look-up table includes a plurality of vertex data, and each vertex data corresponds to a set of color data (for example, a set of RGB data).

In existing technology, the vertex data of the three-dimensional look-up table may be stored in a memory (for example, SRAM). For a pixel that is required to be color-graded, a plurality of vertex data close to the pixel may be searched for and read out from the memory, and a color adjustment result corresponding to the pixel is calculated based on the found vertex data.

A problem of the above solution is that a relatively large amount of vertex data is required to be read each time a color adjustment result is calculated, resulting in relatively high power consumption during the color adjustment process.

### SUMMARY

One aspect of the present disclosure provides a method for data processing. The method includes: obtaining pixel data; determining, according to the pixel data, target type information of the pixel data; obtaining, based on the target type information and mapping unit information determined according to the pixel data, target vertex data corresponding to the target sub-mapping-unit; and, performing interpolation processing on the pixel data according to the target vertex data to obtain a color adjustment result corresponding to the pixel data. The target type information indicates a type of a target sub-mapping-unit to which the pixel data belongs. The mapping unit information indicates a target mapping unit to which the pixel data belongs, the target sub-mapping-unit is one of a plurality of sub-mapping-units included in the target mapping unit, and the target vertex data is a portion of a plurality of vertex data corresponding to the target mapping unit.

Another aspect of the present disclosure provides an electronic device. The electronic device includes: a storage module configured to store a plurality of vertex data; and one or more processors configured to: obtain pixel data; determine target type information of the pixel data according to the pixel data, the target type information indicating a type of a target sub-mapping-unit to which the pixel data belongs; obtain target vertex data corresponding to the target sub-mapping-unit based on the target type information and mapping unit information determined according to the pixel data, the mapping unit information indicating a target mapping unit to which the pixel data belongs, the target sub-mapping-unit being one of a plurality of sub-mapping-units included in the target mapping unit, and the target vertex data being a portion of the plurality of vertex data corresponding to the target mapping unit; and perform interpolation processing on the pixel data according to the target vertex data to obtain a color adjustment result corresponding to the pixel data.

Yet another aspect of the present disclosure provides a non-transitory computer-readable storage medium storing a computer program that, when being executed, causes at least one processor to perform operations including: obtaining pixel data; determining, according to the pixel data, target type information of the pixel data; obtaining, based on the target type information and mapping unit information determined according to the pixel data, target vertex data corresponding to the target sub-mapping-unit; and, performing interpolation processing on the pixel data according to the target vertex data to obtain a color adjustment result corresponding to the pixel data. The target type information indicates a type of a target sub-mapping-unit to which the pixel data belongs. The mapping unit information indicates a target mapping unit to which the pixel data belongs, the target sub-mapping-unit is one of a plurality of sub-mapping-units included in the target mapping unit, and the target vertex data is a portion of the plurality of vertex data corresponding to the target mapping unit.

### BRIEF DESCRIPTION OF THE DRAWINGS

To more clearly illustrate the technical solutions in some embodiments of the present disclosure or in existing technology, the accompanying drawings required in the descriptions of the embodiments or the existing technology are briefly introduced below. It will be apparent that the drawings described below merely illustrate some embodiments of the present disclosure, and those of ordinary skill in the art may derive other drawings based on these drawings without creative effort.

FIG. 1 illustrates a flowchart of a data processing method in accordance with some embodiments of the present disclosure;

FIG. 2 illustrates a schematic diagram of a target mapping unit in accordance with some embodiments of the present disclosure;

FIG. 3 illustrates a schematic diagram of a sub-mapping-unit in accordance with some embodiments of the present disclosure;

FIG. 4 illustrates a schematic diagram of writing vertex data into a storage module in accordance with some embodiments of the present disclosure;

FIG. 5 illustrates a flowchart of a method for reading target vertex data from a storage module in accordance with some embodiments of the present disclosure;

FIG. 6 illustrates a flowchart of a method for determining target type information of pixel data in accordance with some embodiments of the present disclosure;

FIG. 7 illustrates a structural schematic diagram of an electronic device in accordance with some embodiments of the present disclosure;

FIG. 8 illustrates another structural schematic diagram of an electronic device in accordance with some embodiments of the present disclosure; and

FIG. 9 illustrates yet another structural schematic diagram of an electronic device in accordance with some embodiments of the present disclosure.

### DETAILED DESCRIPTION

The technical solutions in some embodiments of the present disclosure are described below clearly and completely with reference to the accompanying drawings. It is apparent that the described embodiments are merely some embodiments of the present disclosure rather than all embodiments. According to the embodiments of the present disclosure, all other embodiments obtained by those of ordinary skill in the art without creative effort shall fall within the protection scope of the present disclosure.

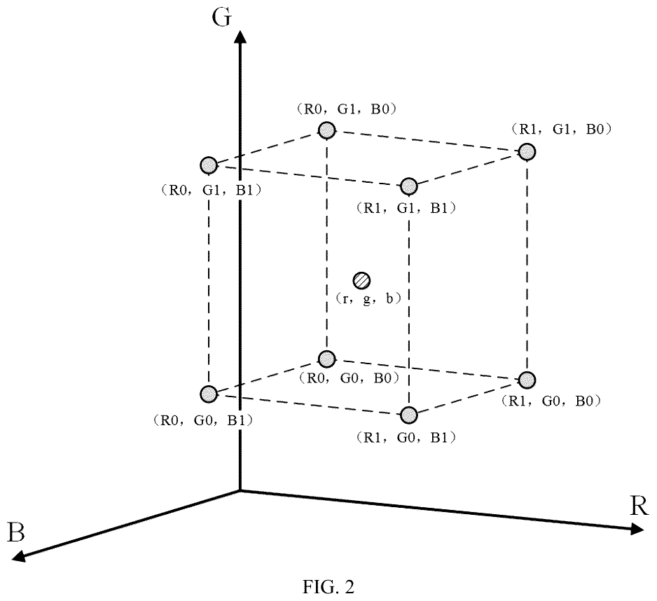

The application manner of a three-dimensional look-up table (3D-LUT) in existing technology is described below by taking an RGB color space as an example. Referring to FIG. 2, for any pixel data (r, g, b), a plurality of vertex data adjacent to the pixel data may be determined in the 3D-LUT. Specifically, 8 vertex data adjacent to one another may be determined, and the 8 vertex data may be represented as (R0, G0, B0), (R0, G0, B1), (R0, G1, B0), (R1, G0, B0), (R1, G1, B0), (R0, G1, B1), (R1, G0, B1), and (R1, G1, B1), as shown in FIG. 2, where R0 is less than R1, G0 is less than G1, and B0 is less than B1. The 8 vertex data form a cube in the RGB color space, and the cube corresponds to a target mapping unit to which the pixel data belongs.

In existing technology, after determining the target mapping unit to which pixel data requiring color adjustment belongs, a processor may read 8 vertex data corresponding to the mapping unit from a storage module, and perform interpolation processing based on the 8 vertex data, so as to obtain a color adjustment result corresponding to the pixel data.

However, analysis of interpolation processing for pixel data shows that, when interpolation processing is performed on any pixel data, only four vertex data among the 8 vertex data included in the target mapping unit are actually used. The four vertex data used for interpolation form a tetrahedron in the RGB color space, and the tetrahedron corresponds to a target sub-mapping-unit to which the pixel data belongs.

In other words, among the 8 vertex data read by the processor within one clock cycle, half of the vertex data are discarded during interpolation processing, and a greater quantity of vertex data read within one clock cycle means that the storage module is required to handle more read operations, which clearly increases power consumption of the storage module.

Based on the above issues, some embodiments of the present disclosure provide a data processing method. The method in this embodiment may be executed by a processor of any electronic device, including but not limited to a computer, a smartphone, or a tablet computer, for example, a graphics processing unit (GPU), a neural network processing unit (NPU), or a dedicated processing module. The following description is provided by taking the processor as an execution entity as an example.

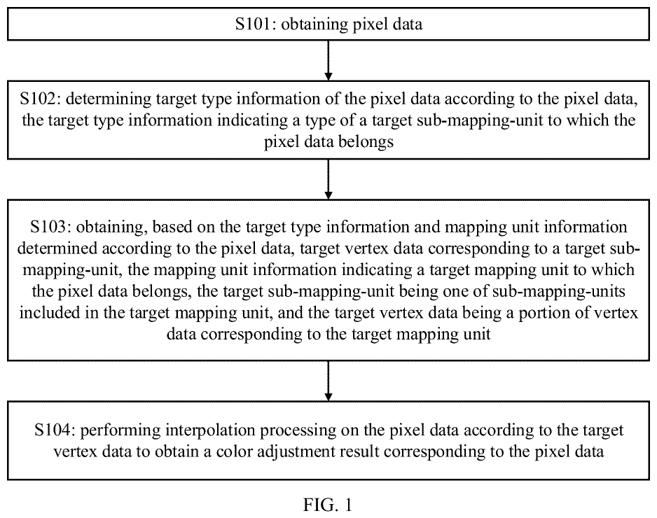

Referring to FIG. 1, the method may include the following steps.

S101: obtaining pixel data.

The data processing method in this embodiment may be applicable to a plurality of scenarios, including but not limited to image processing, film and television production, game development, and virtual reality. The pixel data obtained in S101 may be pixel data required to be processed in these scenarios.

For example, in an image processing scenario, the method in this embodiment may be used to perform color adjustment on a frame of a photograph, and the pixel data may refer to pixel data of each pixel in the frame of the photograph. In a film and television production scenario, the method in this embodiment may be used to perform color adjustment on any video frame of a film or television work, and the pixel data may refer to pixel data of each pixel in the video frame. In a game development scenario, the method in this embodiment may be used to perform color adjustment on any frame of a rendered game image, and the pixel data may refer to pixel data of each pixel in the game image.

The obtained pixel data may be any pixel data required to undergo color adjustment processing.

For example, when color adjustment processing is required to be performed on a frame image A, pixel data included in the frame image A may be obtained sequentially, and each obtained pixel data is processed according to the method in this embodiment to obtain a color adjustment result corresponding to the pixel data. An image obtained by combining the color adjustment results is a color-corrected image A′.

The method in this embodiment may be applied to perform color adjustment processing on pixel data in any color space, including but not limited to HSL (hue, saturation, and value) and RGB (red, green, and blue). For ease of description, the processing method in this embodiment is described below by taking an RGB color space as an example.

As an example, pixel data obtained in this embodiment may be data represented in hexadecimal form in an RGB color space, for example, (FF8, FFF, 5), where FF8, FFF, and 5 respectively correspond to data of an R color component, a G color component, and a B color component of the pixel data.

S102: determining target type information of the pixel data according to the pixel data, the target type information representing a type of a target sub-mapping-unit to which the pixel data belongs.

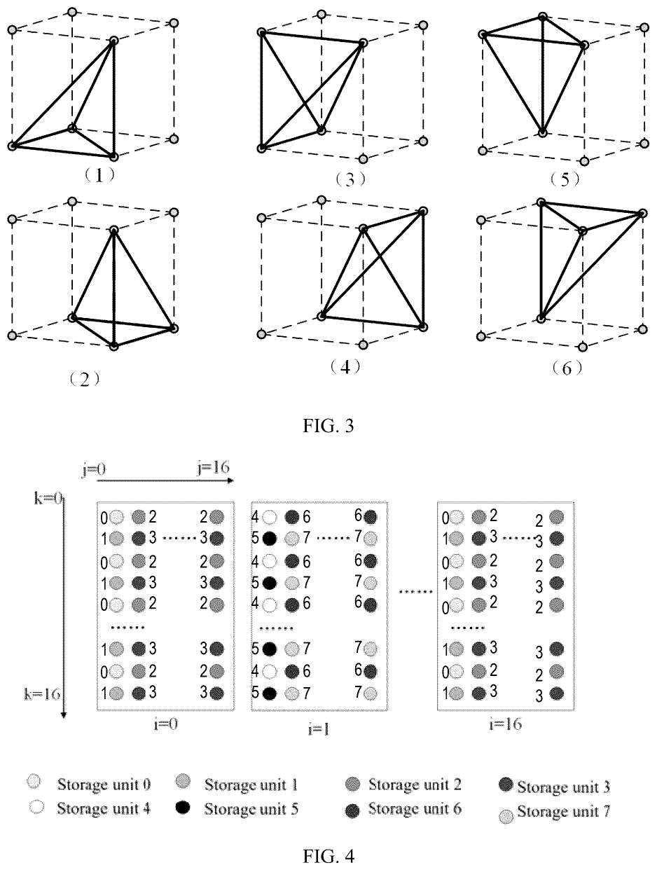

According to different pixel data to be subjected to interpolation processing, relative positions of four vertex data required for interpolation within a mapping unit are different, and accordingly, types of target sub-mapping-units are also different. As an example, for any pixel data, a corresponding target sub-mapping-unit may be any one of tetrahedrons (1) to (6) shown in FIG. 3.

In step S102, based on the currently obtained pixel data, the target sub-mapping-unit to which the pixel data belongs may be determined as one of the types (1) to (6) shown in FIG. 3, and a determined result may be represented by the target type information described above.

The form of the target type information is not limited. As an example, the target type information may be represented by a binary target type signal point_sel[7:0]. The target type signal includes 8 binary bits and may be represented as 8′b10110001. Each binary bit corresponds to one vertex data in the target mapping unit. When a value of a binary bit is 0, it indicates that the corresponding vertex data does not belong to the target sub-mapping-unit, and when a value of a binary bit is 1, it indicates that the corresponding vertex data belongs to the target sub-mapping-unit. Accordingly, a type of the target sub-mapping-unit to which the pixel data belongs may be determined by the target type signal.

An advantage of using point_sel[7:0] as the target type information is that, after address decoding information of the pixel data is obtained, the target type information may be directly mapped to storage unit information based on the address decoding information, thereby determining a storage unit where the target vertex data is stored.

As another example, the six types of sub-mapping-units described above may be numbered. For example, the types (1) to (6) shown in FIG. 3 may be sequentially numbered as T1 to T6, and a target type identifier may be used to represent a type of a target sub-mapping-unit to which the pixel data belongs. For example, when a target type identifier of the pixel data is T3, it indicates that the target sub-mapping-unit to which the pixel data belongs is the type shown in (3) of FIG. 3.

In yet another example, different labels (tags) may be used to represent different types of sub-mapping-units. Correspondingly, the target type information may be a label corresponding to the target sub-mapping-unit. For example, tag1 to tag6 may be used to respectively represent the six types of sub-mapping-units shown in FIG. 3. If a target sub-mapping-unit to which the pixel data belongs is the type shown in (3) of FIG. 3, the obtained target type information may be tag3.

S103: obtaining, based on the target type information and mapping unit information determined according to the pixel data, target vertex data corresponding to a target sub-mapping-unit. The mapping unit information indicates a target mapping unit to which the pixel data belongs, the target sub-mapping-unit is one of a plurality of sub-mapping-units included in the target mapping unit, and the target vertex data is a portion of a plurality of vertex data corresponding to the target mapping unit.

In step S103, the vertex data is pre-stored in a storage module, for example, in SRAM. According to the target type information and the mapping unit information, a storage address of target vertex data corresponding to the target sub-mapping-unit in the storage module may be determined, that is, a target storage address, and the target vertex data is then read from the storage module according to the target storage address.

Mapping unit information may be determined according to pixel data before target type information is determined, may be determined after the target type information is determined, or may be determined simultaneously with the target type information, without limitation.

A 3D-LUT table includes a plurality of vertex data, which may accordingly form a plurality of mapping units as shown in FIG. 2. The mapping unit information may indicate, among the plurality of mapping units, a target mapping unit to which the current pixel data belongs.

The form of the mapping unit information is not limited. In some embodiments of the present disclosure, the mapping unit information may be represented by an index of vertex data in a target mapping unit where color components are all minimum. In combination with the example shown in FIG. 2, the mapping unit information may be an index of vertex data (R0, G0, B0) in the target mapping unit where the color components are minimum.

In a 3D-LUT table, a value range of pixel data may be divided according to specific interval information to form the plurality of vertex data described above.

As an example, when the interval information is 255, a value range from 0 to 4095 in an R color component, a G color component, and a B color component may be divided into 17 values, sequentially being 0, 256, 512, 768, 1024, . . . , 3840, and 4095. By arranging and combining the 17 values of the three color components, 17*17*17 vertex data in the 3D-LUT table may be obtained, for example, (0, 0, 0), (0, 256, 256), and (512, 768, 1024). Further, the 17 values of each color component may be sequentially numbered from 0 to 16 in ascending order, such that vertex data in the 3D-LUT table may be represented by an index (i, j, k) composed of the numbers of the respective color components, where i is a number of the R color component, j is a number of the G color component, and k is a number of the B color component. For example, vertex data (0, 256, 256) corresponds to an index (0, 1, 1), and vertex data (512, 768, 1024) corresponds to an index (2, 3, 4).

In other words, the plurality of vertex data included in the 3D-LUT table is equivalent to a plurality of vertex data obtained by uniformly sampling, starting from an origin, according to interval information in a coordinate system formed by three color components of a color space, each vertex data corresponding to a color in the color space.

The manner of dividing vertex data in the RGB color space described above may also be applicable to other color spaces, and is not limited to the RGB color space.

S104: performing interpolation processing on the pixel data according to the target vertex data to obtain a color adjustment result corresponding to the pixel data.

In step S104, interpolation processing manners applied to pixel data may be different for different types of target sub-mapping-units. In one embodiment, an interpolation algorithm used for interpolation processing may be any interpolation algorithm in existing technology, without limitation. The following describes an example of an applicable interpolation algorithm.

As some examples, if a target sub-mapping-unit belongs to a type T1 shown in FIG. 3, interpolation processing may be performed on the pixel data according to the following formula (1).

$$V ( r , g , b ) = ( 1 - Δ g ) ⋆ ( R 0 , G 0 , B 0 ) + ( Δ g - Δ b ) ⋆ ( R 0 , G 1 , B 0 ) + ( Δ b - Δ r ) ⋆ ( R 0 , G 1 , B 1 ) + Δ r ⋆ ( R 1 , G 1 , B 1 ) . \qquad ( 1 )$$

If the target sub-mapping-unit belongs to a type T2 shown in FIG. 3, interpolation processing may be performed on the pixel data according to the following formula (2).

$$V ( r , g , b ) = ( 1 - Δ b ) ⋆ ( R 0 , G 0 , B 0 ) + ( Δ b - Δ r ) ⋆ ( R 0 , G 0 , B 1 ) + ( Δ r - Δ g ) ⋆ ( R 1 , G 0 , B 1 ) + Δ g ⋆ ( R 1 , G 1 , B 1 ) . \qquad ( 2 )$$

If the target sub-mapping-unit belongs to a type T3 shown in FIG. 3, interpolation processing may be performed on the pixel data according to the following formula (3).

$$V ( r , g , b ) = ( 1 - Δ b ) ⋆ ( R 0 , G 0 , B 0 ) + ( Δ b - Δ g ) ⋆ ( R 0 , G 0 , B 1 ) + ( Δ g - Δ r ) ⋆ ( R 0 , G 1 , B 1 ) + Δ r ⋆ ( R 1 , G 1 , B 1 ) . \qquad ( 3 )$$

If the target sub-mapping-unit belongs to a type T4 shown in FIG. 3, interpolation processing may be performed on the pixel data according to the following formula (4).

$$V ( r , g , b ) = ( 1 - Δ r ) ⋆ ( R 0 , G 0 , B 0 ) + ( Δ r - Δ g ) ⋆ ( R 1 , G 0 , B 0 ) + ( Δ g - Δ b ) ⋆ ( R 1 , G 1 , B 0 ) + Δ b ⋆ ( R 1 , G 1 , B 1 ) . \qquad ( 4 )$$

If the target sub-mapping-unit belongs to a type T5 shown in FIG. 3, interpolation processing may be performed on the pixel data according to the following formula (5).

$$V ( r , g , b ) = ( 1 - Δ g ) ⋆ ( R 0 , G 0 , B 0 ) + ( Δ g - Δ r ) ⋆ ( R 0 , G 1 , B 0 ) + ( Δ r - Δ b ) ⋆ ( R 1 , G 1 , B 0 ) + Δ r ⋆ ( R 1 , G 1 , B 1 ) . \qquad ( 5 )$$

If the target sub-mapping-unit belongs to a type T6 shown in FIG. 3, interpolation processing may be performed on the pixel data according to the following formula (6).

$$V ( r , g , b ) = ( 1 - Δ r ) ⋆ ( R 0 , G 0 , B 0 ) + ( Δ r - Δ b ) ⋆ ( R 1 , G 0 , B 0 ) + ( Δ b - Δ g ) ⋆ ( R 1 , G 0 , B 1 ) + Δ g ⋆ ( R 1 , G 1 , B 1 ) . \qquad ( 6 )$$

As shown in FIG. 2, (R0, G0, B0), (R0, G0, B1), (R0, G1, B0), (R1, G0, B0), (R1, G1, B0), (R0, G1, B1), (R1, G0, B1), and (R1, G1, B1) respectively represent 8 vertex data of a target mapping unit to which pixel data belongs in an RGB color space.

V(r, g, b) indicates a color adjustment result obtained after performing interpolation processing on pixel data (r, g, b). Δr, Δg, and Δb respectively represent feature information corresponding to an R color component, feature information corresponding to a G color component, and feature information corresponding to a B color component. The feature information indicates distances between the pixel data (r, g, b) and vertex data of the target mapping unit. In general, between the pixel data (r, g, b) and the vertex data (R0, G0, B0), a larger deviation between in the R color component corresponds to a larger Δr, a larger deviation in the G color component corresponds to a larger Δg, and a larger deviation in the B color component corresponds to a larger Δb. A manner for determining the feature information is described in relevant sections below.

The above formulas (1) to (6) correspond to six algorithms associated with different types of target sub-mapping-units. Correspondingly, when executing S104, the following steps may be performed: determining a target algorithm corresponding to the target type information; and, performing interpolation processing on the pixel data according to the target vertex data and the target algorithm, to obtain a color adjustment result corresponding to the pixel data.

Beneficial effects of some embodiments of the present disclosure include the following. When performing color adjustment on pixel data, vertex data of a target sub-mapping-unit to which the pixel data belongs may only be read from a storage module, without being required to read vertex data of an entire target mapping unit. Accordingly, the solutions of some embodiments of the present disclosure are capable of reducing an amount of data read from the storage module when performing color adjustment on each pixel data, thereby reducing read operations on the storage module and lowering power consumption of the storage module.

Before performing the data processing method provided in some embodiments of the present disclosure, vertex data in a 3D-LUT table may be written into a storage module in advance, so that corresponding target vertex data is able to be read from the storage module in step S103.

The storage module may include a plurality of storage units. When a processor reads vertex data from the storage module, the processor may simultaneously read one vertex data from each storage unit within one unit time period, where one unit time period may be referred to as one clock cycle. For example, assuming that the storage module includes 8 storage units, the processor may simultaneously read one vertex data from each of the storage units within one clock cycle, that is, the processor may read up to 8 vertex data from the storage module within one clock cycle.

Based on an ability to read 8 vertex data within one clock cycle, the processor may apply the method of some embodiments of the present disclosure to determine, among the 8 vertex data, any number of target vertex data actually required for interpolation processing. Accordingly, fewer than 8 target vertex data (for example, 4 target vertex data) may be read within one clock cycle. This is able to not only reduce a quantity of vertex data read from the storage module, but also complete interpolation processing within a short period of time.

Based on the above characteristics, in order to enable a processor to read 8 vertex data of a target mapping unit from a storage module within one clock cycle, vertex data of a 3D-LUT table may be written into the storage module in the following manner: writing a plurality of vertex data alternately into a plurality of storage units of the storage module, where every two vertex data having adjacent corresponding color components are respectively written into different storage units.

The following description uses an example where the storage module includes 8 storage units for storing vertex data to illustrate the above writing manner.

The 8 storage units of the storage module may be sequentially numbered from 0 to 7, and denoted as storage unit 0 (mem0 ) to storage unit 7 (mem7).

Taking 17*17*17 vertex data as an example, as shown in FIG. 4, vertex data having indices where i=0 and j=0 may first be identified. These vertex data may then be alternately written into storage unit 0 and storage unit 1 in an increasing order of k, where k indicates an index corresponding to a B color component. Vertex data with odd values of k are written into storage unit 1, and vertex data with even values of k are written into storage unit 0. For example, vertex data having indices (0, 0, 0) and (0, 0, 2) are sequentially written into storage unit 0, and vertex data having indices (0, 0, 1) and (0, 0, 3) are sequentially written into storage unit 1.

After the vertex data with i=0 and j=0 are all written, vertex data with indices i=0 and j=1 may be identified. These vertex data may similarly be alternately written into storage unit 2 and storage unit 3 in an increasing order of k, where vertex data. The vertex data with odd values of k are written into storage unit 3 and the vertex data with even values of k are written into storage unit 2.

Thereafter, for vertex data with i=0 and even values of j, the vertex data are alternately written into mem0 and mem1 in the same manner as for the vertex data with i=0 and j=0; and, for vertex data with i=0 and odd values of j, the vertex data are alternately written into mem2 and mem3 in the same manner as for the vertex data with i=0 and j=1. In an increasing order of j, the vertex data with i=0 are written into corresponding storage units in the above manner.

After the vertex data with i=0 are all written, vertex data with indices i=1 and j=0 may be identified. These vertex data may likewise be alternately written into storage unit 4 and storage unit 5 in an increasing order of k. Vertex data with odd values of k are written into storage unit 5, and vertex data with even values of k are written into storage unit 4. After the vertex data with i=1 and j=0 are all written, vertex data with indices i=1 and j=1 may be identified. These vertex data may likewise be alternately written into storage unit 6 and storage unit 7 in an increasing order of k, where vertex data with odd values of k are written into storage unit 7 and vertex data with even values of k are written into storage unit 6.

Subsequently, the vertex data with i=1 and j=2, the vertex data with i=1 and j=3, . . . , and the vertex data with i=1 and j=16 are sequentially written in an increasing order of j, until the vertex data with i=1 are all written. In this process, a writing manner for the vertex data with even values of j refers to the case of i=1 and j=0 described above, and a writing manner for the vertex data with odd values of j refer to the case of i=1 and j=1 described above.

Then, in an increasing order of i, the vertex data with i=2, i=3, . . . , and i=16 are sequentially written into corresponding storage units, until all the vertex data are written. In this process, a writing manner for vertex data with even values of i refer to the case of i=0 described above, and a writing manner for vertex data with odd values of i refer to the case of i=1 described above.

In FIG. 4, each dot indicates a vertex data, and the color of the dot indicates a storage unit storing the vertex data. Vertex data of a same color are stored in a same storage unit, and vertex data of different colors are stored in different storage units.

By writing the vertex data in the manner described above, any two adjacent vertex data in any direction of R, G, and B in the color space are stored in different storage units, and 8 vertex data of any mapping unit are each able to be stored in 8 different storage units respectively. Based on this, for any type of target sub-mapping-unit, a processor is able to find target vertex data corresponding to the target sub-mapping-unit in a plurality of different storage units, thereby simultaneously reading the target vertex data from the plurality of different storage units within one clock cycle.

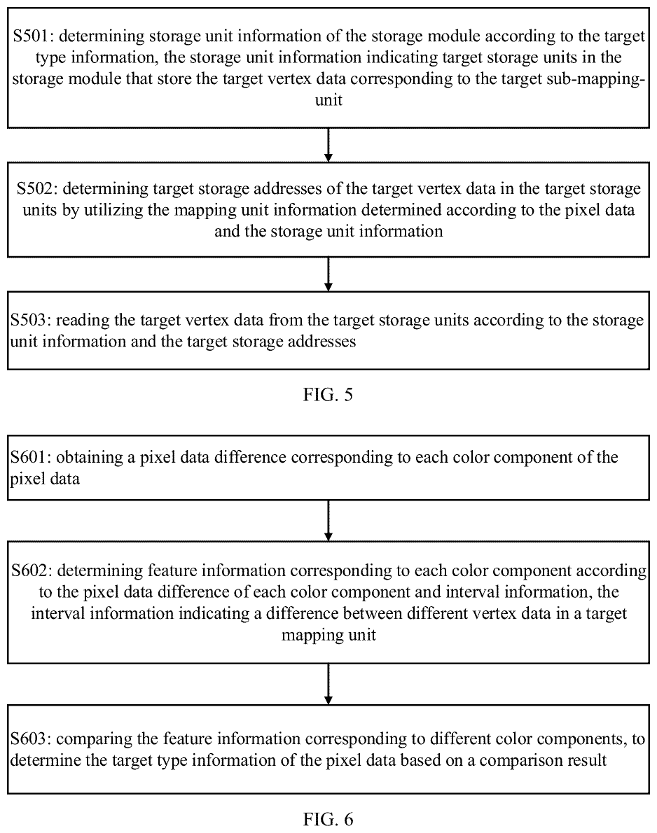

Please refer to FIG. 5. Based on the target type information and the mapping unit information determined according to the pixel data, the manner of reading the target vertex data may include:

S501: determining storage unit information of the storage module according to the target type information. The storage unit information indicates target storage units in the storage module that store the target vertex data corresponding to the target sub-mapping-unit.

S502: determining target storage addresses of the target vertex data in the target storage units by utilizing the mapping unit information determined according to the pixel data and the storage unit information.

S503: reading the target vertex data from the target storage units according to the storage unit information and the target storage addresses.

In S501, the storage unit information may be represented in various forms. For example, the storage unit information may be an array, where each element in the array corresponds to one target vertex data, and a value of each element indicates an identifier of a target storage unit that stores the target vertex data. Or, the storage unit information may be an N-bit binary number, where N is equal to a quantity of storage units used for storing vertex data, and each binary bit in the binary number corresponds to one storage unit. If a value of a binary bit is 0, its corresponding storage unit is not a target storage unit and the target vertex data is not stored in the storage unit; and, if a value of a binary bit is 1, its corresponding storage unit is a target storage unit and the target vertex data is stored in the storage unit.

In combination with the above-described example of writing the vertex data into the 8 storage units of the storage module, the storage unit information may be an 8-bit binary number, represented by mem_sel[7:0]. By way of example, storage unit information mem_sel[7:0] determined according to target type information point_sel[7:0]=8′b10110001 may be 8′b11101000. In the storage unit information, 8 binary bits from right to left sequentially correspond to the above-described storage unit 0 to storage unit 7. A storage unit corresponding to a binary bit having a value of 1 is the target storage unit. In this example, the values of the 4-th, 6-th, 7-th, and 8-th binary bits starting from the right end are 1, indicating that the target storage units include storage unit 3, storage unit 5, storage unit 6, and storage unit 7.

In S501, a manner of determining the storage unit information of the storage module according to the target type information may be: obtaining address decoding information of the pixel data, where the address decoding information indicates a storage unit where vertex data corresponding to a minimum color component in the target mapping unit is located; and, determining the storage unit information of the storage module according to the address decoding information and the target type information.

For any pixel data, a first manner of obtaining the address decoding information of the pixel data may include: representing each of the color components of the pixel data as a binary number, then, in the binary number, determining all binary bits required for representing interval information of the 3D-LUT table from low to high, and obtaining a lowest bit of the remaining binary bits other than the binary bits required for representing the interval information. Information obtained by combining the lowest bits obtained in this manner from each of the color components may serve as the address decoding information of the pixel data.

As an example, when a value range of each color component of the pixel data is 0 to 4095, interval information of the 3D-LUT table is 255, and a color space is RGB, each color component may be represented by a 12-bit binary number. Representing 255 requires occupying the 0-th binary bit to the 7-th binary bit. Therefore, a lowest bit may be obtained from remaining binary bits other than the 0-th binary bit to the 7-th binary bit. That is, an 8-th binary bit of each color component is obtained and combined to generate the address decoding information.

For the pixel data in the RGB color space, a combination manner may be as follows. A 3-bit binary number may be generated by combining, from high to low, an 8-th binary bit of a B color component (represented as dat_b[8]), an 8-th binary bit of a G color component (represented as dat_g[8]), and an 8-th binary bit of a R color component (represented as dat_r[8]) to obtain a 3-bit binary number. The 3-bit binary number is an identifier of a storage unit where vertex data corresponding to minimum color components in a target mapping unit is located.

In some embodiments of the present disclosure, when each color component of pixel data is represented in hexadecimal, a value range of each color component of the pixel data is from 0 to 4095, and interval information of a 3D-LUT table is 255, a second manner of obtaining address decoding information may further include: combining data of a first bit in a most significant bit (MSB) of each of the color components of the pixel data, to obtain address decoding information of the pixel data.

In the present disclosure, a most significant bit (MSB) characterizes logical bit segments or logical positions of data, may include one or more binary bits depending on a data representation format, and is not limited to a single binary bit. The first bit in the most significant bit refers to, after converting the most significant bit into a binary number, a lowest binary bit (from right to left) in the binary number.

By way of example, if an R color component of pixel data is a hexadecimal number F94, a most significant bit (MSB) of the R color component is F at a first position on a left side. After converting F into a binary number 1111, a first binary bit at a right end of the binary number is a first bit in the MSB of the R color component.

A manner of combining may refer to the first obtaining manner described above and is not repeated herein.

It may be seen that, when a value range is from 0 to 4095, an 8-th binary bit of a color component represented in binary is identical to a first bit in a most significant bit of the color component represented in hexadecimal. Therefore, the above-described second manner of obtaining address decoding information may be regarded as a special case of the first manner of obtaining address decoding information when color components are represented in hexadecimal and interval information is 255.

By way of example, pixel data obtained in S101 may be (FF8, DFF, 5). An R color component of the pixel data is a hexadecimal number FF8, a G color component of the pixel data is a hexadecimal number DFF, and a B color component of the pixel data is a hexadecimal number 005. A most significant digit of the R color component is F, which is converted into a binary number 1111, and a first bit (from right) of the binary number is 1. A most significant digit of the G color component is D, which is converted into a binary number 1101, and a first bit of the binary number is 1. A most significant digit of the B color component is 0, which is converted into a binary number 0000, and a first bit of the binary number is 0. These three bits are combined in an order of B, G, and R to obtain a binary number 011. Accordingly, address decoding information of the pixel data (FF8, DFF, 5) is 011, indicating that a storage unit where vertex data corresponding to minimum color components in a target mapping unit are stored is storage unit 3 (i.e., mem3).

Vertex data corresponding to minimum color components in a target mapping unit refers to vertex data in the target mapping unit where a value of each color component is less than or equal to corresponding values of other vertex data in the target mapping unit. With reference to the example shown in FIG. 2, vertex data corresponding to minimum color components in the target mapping unit may be vertex data (R0, G0, B0) shown in FIG. 2.

Since each color component of vertex data sequentially corresponds to index numbers i, j, and k, in combination with the above-described manner of writing vertex data into the storage module, after determining a storage unit where the vertex data corresponding to minimum color components in the target mapping unit are stored, storage units where target vertex data in the target mapping unit are stored may be sequentially determined.

With reference to the example shown in FIG. 2, after determining that (R0, G0, B0) is stored in storage unit 3, it may be determined, based on the writing manner shown in FIG. 4, that (R0, G0, B1), which is adjacent to (R0, G0, B0) in a B color component, is stored in storage unit 2; (R1, G0, B0), which is adjacent to (R0, G0, B0) in an R color component, is stored in storage unit 7; (R0, G1, B0), which is adjacent to (R0, G0, B0) in a G color component, is stored in storage unit 1; (R1, G0, B1), which is adjacent to (R0, G0, B1), is stored in storage unit 6, and (R0, G1, B1) is stored in storage unit 0; (R1, G1, B0), which is adjacent to (R0, G1, B0), is stored in storage unit 5; and, (R1, G1, B1), which is adjacent to (R0, G1, B1), is stored in storage unit 4.

When obtaining storage unit information, assuming that target type information indicates, in the target mapping unit of FIG. 2, that target vertex data include (R0, G0, B0), (R1, G0, B0), (R1, G1, B1), and (R1, G1, B0), it may be determined that the four target vertex data are respectively stored in storage unit 3, storage unit 7, storage unit 4, and storage unit 5, and corresponding storage unit information is 8′b10111000.

In step S502, according to a correspondence between color components of vertex data and indices of the vertex data, indices of the target vertex data in the target mapping unit may be determined based on an index of vertex data corresponding to minimum color components in the target mapping unit. Further, according to a mapping relationship between the indices and storage addresses of the vertex data in storage units, a target storage address of each target vertex data within the target mapping unit may be determined.

A mapping relationship between indices and storage addresses of vertex data in storage units may be recorded when vertex data are written into the storage module. A manner of determining storage addresses based on indices and the mapping relationship may refer to existing technology and is not described in detail herein.

In step S503, based on the storage unit information, storage addresses of target vertex data in corresponding target storage units may be output to the storage module, and read enable signals of the target storage units may be output, such that a plurality of target vertex data are read simultaneously from a plurality of different target storage units of the storage module within one clock cycle.

With reference to FIG. 6, in one embodiment, in step S102, a manner of determining target type information of pixel data according to the pixel data may include:

S601: obtaining a pixel data difference corresponding to each color component of the pixel data.

S602: determining feature information corresponding to each color component according to the pixel data difference of each color component and interval information, where the interval information indicates a difference between different vertex data in a target mapping unit.

S603: comparing the feature information corresponding to different color components, to determine the target type information of the pixel data based on a comparison result.

A pixel data difference of the pixel data on any color component may be understood as, on the color component, a difference between the pixel data and vertex data (R0, G0, B0) having minimum color components in a target mapping unit where the pixel data is located.

By taking an RGB color space as an example and with reference to FIG. 2, for any pixel data (r, g, b), a pixel data difference on an R color component is a difference between r of the pixel data and R0 of (R0, G0, B0), that is, r−R0. Similarly, a pixel data difference on a G color component is g−G0, and a pixel data difference on a B color component is b−B0.

In step S601, a manner of obtaining a pixel data difference of a color component in the pixel data may include: representing the color component of the pixel data as a binary number, obtaining data of all binary bits required for representing interval information from the binary number, and using the data as the pixel data difference of the color component.

By way of example, it is assumed that a value range of a color component of pixel data is from 0 to 4095. The color component may be represented in binary as a binary number including 12 binary bits (i.e., a 0-th bit to an 11-th bit). If interval information is 255, all binary bits required for representing the interval information in the 12-bit binary number representing the color component include the 0-th bit to the 7-th bit (that is, lower 8 binary bits). Accordingly, the 0-th bit to the 7-th bit of the 12-bit binary number representing the color component may be obtained as a pixel data difference of the color component. As an example, it is assumed that a color component r of pixel data is represented in binary as 001101001100. A pixel data difference of the pixel data on an R color component may be represented as 01001100, and a corresponding decimal number is 76.

When color components of pixel data are represented in hexadecimal and interval information is 255, data of a least significant bit (LSB) of a color component are equivalent to data of all binary bits required for representing the interval information when the color component is represented in binary. Therefore, when color components of pixel data are represented in hexadecimal and interval information is 255, a manner of obtaining a pixel data difference of each color component may further include: obtaining data located at a least significant bit of each color component of the pixel data as the pixel data difference of each color component.

In the present disclosure, a least significant bit (LSB) characterizes logical bit segments or logical positions of data, may include one or more binary bits depending on a data representation format, and is not limited to a single binary bit. A least significant bit (LSB) of a color component may include bits of the color component other than a most significant bit. By way of example, for pixel data (FF8, DFF, 5) represented in hexadecimal, in R color component data FF8, data of the least significant bit may be F8; in G color component data DFF, data of the least significant bit may be FF; and in B color component data 5 (equivalent to 005), data of the least significant bit may be 05.

In step S602, a difference between vertex data corresponding to a maximum color component and vertex data corresponding to a minimum color component on a corresponding color component may be calculated, and a calculation result may be used as interval information. Alternatively, interval information may be recorded in advance when a 3D-LUT table is written into the storage module, and the recorded interval information may be directly read in step S602.

In combination with FIG. 2, interval information obtained in step S602 may include R1 −R0 corresponding to an R color component, G1−G0 corresponding to a G color component, and B1−B0 corresponding to a B color component.

Feature information corresponding to each color component may be obtained by dividing a pixel data difference corresponding to the color component by interval information corresponding to the color component.

By taking an RGB color space as an example, Δr, Δg, and Δb sequentially represent feature information corresponding to an R color component, feature information corresponding to a G color component, and feature information corresponding to a B color component. The above feature information may be determined according to the following formulas (7) to (9):

$$Δ r = ( r - R 0 ) / ( R 1 - R 0 ) ; \qquad ( 7 )$$

$$Δ g = ( g - G 0 ) / ( G 1 - G 0 ) ; \qquad ( 8 )$$

$$and$$

$$Δ b = ( b - B 0 ) / ( B 1 - B 0 ) . \qquad ( 9 )$$

In step S603, target type information of the pixel data may be determined based on the following strategy in combination with the comparison result:
if the comparison result is Δb>Δr>Δg, a type of the target sub-mapping-unit may be determined to be T1, and in this case, the target type information may be 8′b11010001;
if the comparison result is Δb>Δg>Δr, the type of the target sub-mapping-unit may be determined to be T2, and in this case, the target type information may be 8′b11000101;
if the comparison result is Δr>Δg>Δb, the type of the target sub-mapping-unit may be determined to be T3, and in this case, the target type information may be 8′b10110001;
if the comparison result is Δr>Δb>Δg, the type of the target sub-mapping-unit may be determined to be T4, and in this case, the target type information may be 8′b10001101;
if the comparison result is Δg>Δr>Δb, the type of the target sub-mapping-unit may be determined to be T5, and in this case, the target type information may be 8′b10100011; and
if the comparison result is not any of the foregoing five cases, the type of the target sub-mapping-unit may be determined to be T6, and in this case, the target type information may be 8′b10001011.

For example, after directly obtaining least significant bits of each color component as feature information, in order to input the feature information and target vertex data simultaneously into an interpolation module for performing interpolation processing and jointly participating in interpolation calculation, the obtained feature information may be stored in the following manner: feature information corresponding to each color component may be registered in a register for a target duration, and feature information corresponding to each color component may be read from the register after the target duration. At this time, obtaining the target vertex data from the storage module has been completed, such that interpolation processing may be performed on pixel data according to the feature information. The target duration is a duration required for reading the target vertex data from the storage module.

The target duration may be determined according to a structure of an electronic device executing the method of the present disclosure. In some embodiments of the present disclosure, after feature information is obtained, two clock cycles, that is, a duration of two clock cycles, may be used to read the target vertex data from the storage module. One clock cycle may be used to determine a storage address and a storage unit where the target vertex data are stored, and one clock cycle may be used to read the target vertex data according to the storage address and the storage unit. Accordingly, the target duration may be two clock cycles.

Determining mapping unit information according to pixel data may include: obtaining, for each color component of the pixel data, data located at a most significant bit; and, determining the mapping unit information according to the data at the most significant bit of each color component.

In this embodiment, when each color component of the pixel data is represented in hexadecimal, a value range of each color component of the pixel data is from 0 to 4095, and interval information of a 3D-LUT table is 255, for each color component, data located at the most significant bit of the color component may be obtained, and the data may be used as a corresponding index number in an index of vertex data. An index composed of index numbers of three color components obtained in this manner may be used as the mapping unit information of the pixel data.

By way of example, for pixel data (FF8, FFF, 5), for an R color component, a hexadecimal representation is FF8, and data located at a most significant bit is F, such that a corresponding index number is 15. For a G color component, a hexadecimal representation is FFF, and data located at a most significant bit are F, such that a corresponding index number is 15. For a B color component, a hexadecimal representation is 005, and data located at a most significant bit are 0, such that a corresponding index number is 0. An index (15, 15, 0) composed of these three index numbers is the index of the vertex data having a minimum color component in each color component in the target mapping unit.

When at least one of the following two conditions is not satisfied, that is, a value range of each color component of the pixel data is from 0 to 4095 and interval information of a 3D-LUT table is 255, mapping unit information may be determined according to the following method: representing a color component in binary, obtaining data of remaining binary bits in the color component other than binary bits required for representing the interval information, using the data of the remaining binary bits to replace data located at a most significant bit used in the above-described method for determining the mapping unit information, and then determining the mapping unit information based on the above-described method.

The data processing method provided in the present disclosure may be applicable to an electronic device that performs color adjustment based on any interpolation algorithm among tetrahedral interpolation, prism interpolation, and pyramid interpolation.

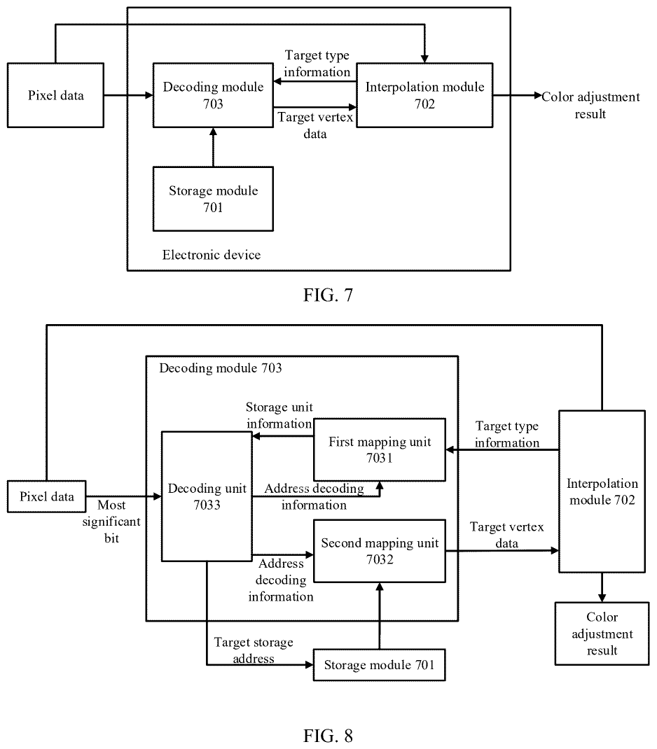

Various embodiments of the present disclosure further provide an electronic device. With reference to FIG. 7, the electronic device may include:
a storage module 701 (which may also be referred to as a 3D LUT SRAM), configured to store a plurality of vertex data;
an interpolation module 702 (which may also be referred to as tetrahedral interpolation), configured to: obtain pixel data; and, determine target type information of the pixel data according to the pixel data, where the target type information indicates a type of a target sub-mapping-unit to which the pixel data belong; and
a decoding module 703, configured to read, from the storage module, target vertex data corresponding to the target sub-mapping-unit based on the target type information and mapping unit information determined according to the pixel data, where the mapping unit information indicates a target mapping unit to which the pixel data belong, the target sub-mapping-unit is one of a plurality of sub-mapping-units included in the target mapping unit, and the target vertex data are a part of a plurality of vertex data corresponding to the target mapping unit.

The interpolation module 702 is further configured to perform interpolation processing on the pixel data according to the target vertex data, to obtain a color adjustment result corresponding to the pixel data.

With reference to FIG. 8, the decoding module 703 may include a first mapping unit 7031 (which may also be referred to as point-to-memory mapping logic), a second mapping unit 7032 (which may also be referred to as memory-to-point mapping logic), and a decoding unit 7033 (which may also be referred to as address decode).

For example, the decoding module 703 reads, from the storage module, target vertex data corresponding to a target sub-mapping-unit based on the target type information and the mapping unit information determined according to the pixel data. The reading process may include:
the first mapping unit 7031 determining storage unit information of the storage module according to the target type information, where the storage unit information indicates target storage units in the storage module that store the target vertex data corresponding to the target sub-mapping-unit;
the decoding unit 7033 determining, based on the storage unit information and the mapping unit information determined according to the pixel data, a target storage address of the target vertex data within the target storage units; and
the decoding unit 7033 reading the target vertex data from the target storage units based on the storage unit information and the target storage address.

The target vertex data read out may first enter the second mapping unit 7032. The second mapping unit 7032 maps the data read from the target storage units to corresponding target vertex data according to address decoding information, that is, determines which vertex in the target mapping unit corresponds to the vertex data read from each target storage unit. The second mapping unit 7032 may then provide the target vertex data to the interpolation module 702.

By way of example, after determining that the target storage units include storage unit 3, storage unit 7, storage unit 4, and storage unit 5, and after determining the target storage address, the decoding unit 7033 reads four vertex data from storage units 3, 7, 5, and 4 according to the target storage address. After obtaining the four vertex data, the second mapping unit 7032 determines, based on the address decoding information, that the vertex data read from storage unit 3 corresponds to (R0, G0, B0) of the target mapping unit, the vertex data read from storage unit 7 corresponds to (R1, G0, B0) of the target mapping unit, the vertex data read from storage unit 4 corresponds to (R1, G1, B1) of the target mapping unit, and the vertex data read from storage unit 5 corresponds to (R1, G1, B0) of the target mapping unit. Accordingly, the mapping from the data read from the target storage units to the target vertex data is completed. After the target vertex data are input to the interpolation module 702, the interpolation module 702 may directly use the target vertex data to perform interpolation processing on the pixel data.

The manner of mapping the vertex data read from each of the target storage units to the target vertex data may refer to the foregoing manner of determining the storage unit information based on the target type information and the address decoding information, and details are not repeated herein.

The first mapping unit 7031 determining the storage unit information of the storage module according to the target type information may include: obtaining the address decoding information of the pixel data output by the decoding unit 7033, where the address decoding information indicates a storage unit in which vertex data having a minimum color component in the target mapping unit is stored; and, determining the storage unit information of the storage module according to the address decoding information and the target type information.

The decoding unit 7033 obtaining the address decoding information of the pixel data may include: combining data of a first bit in the most significant bit of each color component of the pixel data to obtain the address decoding information of the pixel data.

The interpolation module 702 determining target type information of the pixel data according to the pixel data may include: obtaining data located at a least significant bit of each color component of the pixel data as a pixel data difference of each color component; determining feature information corresponding to each color component according to interval information and the pixel data difference of each color component, where the interval information indicates a difference between different vertex data within the target mapping unit; and, comparing the feature information corresponding to different color components, to determine the target type information of the pixel data based on a comparison result.

The interpolation module 702 may include a register, and the interpolation module 702 may be further configured to: register the feature information corresponding to each color component in the register for a target duration, and read the feature information corresponding to each color component from the register after the target duration, to perform interpolation processing on the pixel data according to the feature information, where the target duration is a duration required for reading the target vertex data from the storage module.

The mapping unit information may be determined by the decoding unit 7033. The decoding unit 7033 determining the mapping unit information according to the pixel data may include: obtaining data located at a most significant bit of each color component of the pixel data; and determining the mapping unit information according to the data located at the most significant bit of each color component.

The interpolation module 702 performing interpolation processing on the pixel data according to the target vertex data to obtain a color adjustment result corresponding to the pixel data may include: determining a target algorithm corresponding to the target type information; and, performing interpolation processing on the pixel data according to the target vertex data and the target algorithm, to obtain the color adjustment result corresponding to the pixel data.

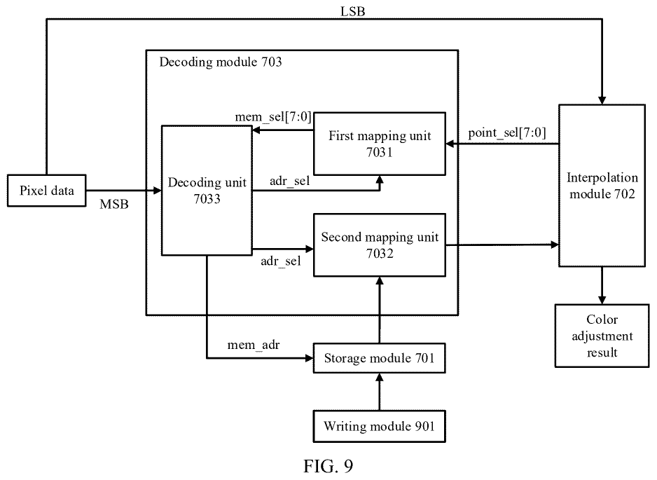

Referring to FIG. 9, in some electronic devices, a writing module 901 (which may also be referred to as a Reg Configuration module) may further be included, and may be configured to alternately write a plurality of vertex data into a plurality of storage units of the storage module 701, where every two vertex data having adjacent corresponding color components are respectively written into different storage units.

Referring to FIG. 9, the operating principle of the aforementioned electronic device is described below in combination with an example.

The interpolation module 702 determines target type information point_sel[7:0] according to the LSB of the pixel data. The decoding unit 7033 determines address decoding information adr_sel according to the MSB of the pixel data. The first mapping unit 7031 obtains point_sel[7:0] and adr_sel, and determines storage unit information mem_sel[7:0] based on point_sel[7:0]. The decoding unit 7033 determines mapping unit information of the pixel data based on the MSB of the pixel data, and determines a target storage address mem_adr of the target vertex data corresponding to the pixel data in the storage module 701 in combination with mem_sel[7:0]. The target storage address is output to the storage module 701, such that vertex data are read from the respective target storage units of the storage module 701 according to the target storage address.

The second mapping unit 7032 obtains the address decoding information adr_sel, maps vertex data output from the respective target storage units into target vertex data corresponding to the pixel data based on adr_sel, and transmits the target vertex data to the interpolation module 702. The interpolation module 702 performs interpolation processing on the pixel data based on the target vertex data, to obtain a color adjustment result.

The operating principle of the above electronic device may be understood with reference to the related steps of the data processing method according to the foregoing embodiments of the present disclosure.

It should be noted that the embodiments described in this specification are presented in a progressive manner. Each embodiment focuses on differences from other embodiments, and identical or similar parts among the embodiments may be referenced to one another.

For convenience of description, when describing the above system or apparatus, various modules or units are described separately according to their functions. However, during implementation of the present disclosure, the functions of the units may be implemented in the same software and/or hardware, or in a plurality of software and/or hardware components.

From the description of the above embodiments, those of ordinary skill in the art may clearly understand that the present disclosure may be implemented by software in combination with required general-purpose hardware platforms. Based on such an understanding, the technical solutions of the present disclosure, in essence or the portions contributing to existing technology, may be embodied in the form of a software product. The computer software product may be stored in a storage medium, such as ROM, RAM, a magnetic disk, an optical disk, or the like, and may include a plurality of instructions for causing a computer device (which may be a personal computer, a server, or a network device, among others) to perform the methods described in the embodiments of the present disclosure or parts of the embodiments.

Finally, it should also be noted that, in this specification, relational terms such as first, second, third, and fourth are used merely to distinguish one entity or operation from another entity or operation, and do not necessarily require or imply any actual relationship or order between such entities or operations. In addition, the terms “include”, “includes”, or any variations thereof are intended to cover non-exclusive inclusion, such that a process, method, article, or device that includes a series of elements includes not only those elements, but also other elements not expressly listed, or elements inherent to such a process, method, article, or device. Without further limitation, an element defined by the phrase “includes a . . . ” does not exclude the presence of additional identical elements in the process, method, article, or device that includes the element.

The above descriptions are only preferred embodiments of the present disclosure. It should be pointed out that, for those of ordinary skill in the art, various improvements and modifications may be made without departing from the principles of the present disclosure, and such improvements and modifications should also be regarded as falling within the scope of protection of the present disclosure.

What is claimed is:

1. A method for data processing, comprising:
obtaining pixel data;
determining, according to the pixel data, target type information of the pixel data, wherein the target type information indicates a type of a target sub-mapping-unit to which the pixel data belongs;
obtaining, based on the target type information and mapping unit information determined according to the pixel data, target vertex data corresponding to the target sub-mapping-unit, wherein the mapping unit information indicates a target mapping unit to which the pixel data belongs, the target sub-mapping-unit is one of a plurality of sub-mapping-units included in the target mapping unit, and the target vertex data is a portion of a plurality of vertex data corresponding to the target mapping unit; and
performing interpolation processing on the pixel data according to the target vertex data to obtain a color adjustment result corresponding to the pixel data.

2. The method according to claim 1, wherein obtaining the target vertex data corresponding to the target sub-mapping-unit based on the target type information and the mapping unit information determined according to the pixel data comprises:
determining storage unit information of a storage module according to the target type information, wherein the storage unit information indicates target storage units in the storage module that stores the target vertex data corresponding to the target sub-mapping-unit;
determining, by using the mapping unit information determined according to the pixel data, target storage addresses of the target vertex data within the target storage units; and
reading the target vertex data from the target storage units according to the storage unit information and the target storage addresses.

3. The method according to claim 2, wherein determining the storage unit information of the storage module according to the target type information comprises:
obtaining address decoding information of the pixel data, wherein the address decoding information indicates a storage unit in which vertex data having minimum values for respective color components in the target mapping unit is located; and
determining the storage unit information of the storage module according to the address decoding information and the target type information.

4. The method according to claim 3, wherein obtaining the address decoding information of the pixel data comprises:
combining data of a first bit in a most significant bit of each color component of the pixel data to obtain the address decoding information of the pixel data.

5. The method according to claim 1, wherein determining the target type information of the pixel data according to the pixel data comprises:
obtaining data at a least significant bit of each color component of the pixel data as a pixel data difference of each color component;
determining feature information corresponding to each color component according to interval information and the pixel data difference of each color component, wherein the interval information indicates a difference between different vertex data in the target mapping unit; and
comparing the feature information corresponding to different color components to determine the target type information of the pixel data based on a comparison result.

6. The method according to claim 5, further comprising:
registering the feature information corresponding to each color component in a register for a target duration, and reading the feature information corresponding to each color component from the register after the target duration, to perform the interpolation processing on the pixel data according to the feature information, wherein the target duration is a duration required for reading the target vertex data from a storage module.

7. The method according to claim 1, wherein determining the mapping unit information according to the pixel data comprises:
obtaining data at a most significant bit of each color component of the pixel data; and
determining the mapping unit information according to the data at the most significant bit of each color component.

8. The method according to claim 1, further comprising:
alternately writing the plurality of vertex data into a plurality of storage units of a storage module, wherein every two vertex data adjacent in at least one color component direction are respectively written into different storage units.

9. The method according to claim 1, wherein performing the interpolation processing on the pixel data according to the target vertex data to obtain the color adjustment result corresponding to the pixel data comprises:
determining a target algorithm corresponding to the target type information; and
performing the interpolation processing on the pixel data according to the target vertex data and the target algorithm to obtain the color adjustment result corresponding to the pixel data.

10. An electronic device, comprising:
a storage module configured to store a plurality of vertex data; and
one or more processors configured to:
obtain pixel data;
determine target type information of the pixel data according to the pixel data, wherein the target type information indicates a type of a target sub-mapping-unit to which the pixel data belongs;
obtain target vertex data corresponding to the target sub-mapping-unit based on the target type information and mapping unit information determined according to the pixel data, wherein the mapping unit information indicates a target mapping unit to which the pixel data belongs, the target sub-mapping-unit is one of a plurality of sub-mapping-units included in the target mapping unit, and the target vertex data is a portion of the plurality of vertex data corresponding to the target mapping unit; and
perform interpolation processing on the pixel data according to the target vertex data to obtain a color adjustment result corresponding to the pixel data.

11. The device according to claim 10, wherein the one or more processors are further configured to:
determine storage unit information of a storage module according to the target type information, wherein the storage unit information indicates target storage units in the storage module that store the target vertex data corresponding to the target sub-mapping-unit;
determine, by using the mapping unit information determined according to the pixel data, target storage addresses of the target vertex data within the target storage units; and
read the target vertex data from the target storage units according to the storage unit information and the target storage addresses.

12. The device according to claim 11, wherein the one or more processors are further configured to:
obtain address decoding information of the pixel data, wherein the address decoding information indicates a storage unit in which vertex data having minimum values for respective color components in the target mapping unit is located; and
determine the storage unit information of the storage module according to the address decoding information and the target type information.

13. The device according to claim 12, wherein the one or more processors are further configured to:
combine data of a first bit in a most significant bit of each color component of the pixel data to obtain the address decoding information of the pixel data.

14. The device according to claim 10, wherein the one or more processors are further configured to:
obtain data at a least significant bit of each color component of the pixel data as a pixel data difference of each color component;
determine feature information corresponding to each color component according to interval information and the pixel data difference of each color component, wherein the interval information indicates a difference between different vertex data in the target mapping unit; and
compare the feature information corresponding to different color components to determine the target type information of the pixel data based on a comparison result.

15. The device according to claim 14, wherein the one or more processors are further configured to:
register the feature information corresponding to each color component in a register for a target duration, and read the feature information corresponding to each color component from the register after the target duration, to perform the interpolation processing on the pixel data according to the feature information, wherein the target duration is a duration required for reading the target vertex data from a storage module.

16. The device according to claim 10, wherein the one or more processors are further configured to:
obtain data at a most significant bit of each color component of the pixel data; and
determine the mapping unit information according to the data at the most significant bit of each color component.

17. The device according to claim 10, wherein the one or more processors are further configured to:
alternately write the plurality of vertex data into a plurality of storage units of a storage module, wherein every two vertex data adjacent in at least one color component direction are respectively written into different storage units.

18. The device according to claim 10, wherein the one or more processors are further configured to:
determine a target algorithm corresponding to the target type information; and
perform the interpolation processing on the pixel data according to the target vertex data and the target algorithm to obtain the color adjustment result corresponding to the pixel data.

19. A non-transitory computer-readable storage medium storing a computer program that, when being executed, causes at least one processor to perform operations comprising:
obtaining pixel data;
determining, according to the pixel data, target type information of the pixel data, wherein the target type information indicates a type of a target sub-mapping-unit to which the pixel data belongs;
obtaining, based on the target type information and mapping unit information determined according to the pixel data, target vertex data corresponding to the target sub-mapping-unit, wherein the mapping unit information indicates a target mapping unit to which the pixel data belongs, the target sub-mapping-unit is one of a plurality of sub-mapping-units included in the target mapping unit, and the target vertex data is a portion of a plurality of vertex data corresponding to the target mapping unit; and
performing interpolation processing on the pixel data according to the target vertex data to obtain a color adjustment result corresponding to the pixel data.

20. The non-transitory computer-readable storage medium according to claim 19, wherein the operations further comprise:
determining the target type information based on least significant bits of color components of the pixel data; and
determining the mapping unit information based on most significant bits of the color components of the pixel data.
